(19) United States
(12) Patent Application Publication
(10) Pub. No.: US 2005/0253005 A1
(43) Pub. Date: Nov. 17, 2005

(54) Hand held paper shredder

(76) Inventor: Brian T. Watanabe, Honolulu, HI (US)

Correspondence Address: LITMAN LAW OFFICES, LTD, PO BOX 15035, CRYSTAL CITY STATION, ARLINGTON, VA, 22215, US

(21) Appl. No.: 10/845,535

(22) Filed: May 14, 2004

(51) Int. Cl. B02C 18/16

(52) U.S. Cl. 241/169.1; 241/236

(57) ABSTRACT

The hand held paper shredder is provided in the form of a hollow flag-shaped housing having a flag portion and a staff portion. Cutting wheel assemblies are rotatably positioned within the flag portion. The flag portion includes a narrow gap exposing the cutting wheel assemblies and a recessed switch assembly having a spring biased actuating arm positioned within the gap for activating a motor mounted in the shaft portion. At least one rechargeable battery is mounted in the staff portion. Suitable gearing connects the drive gear on the motor drive shaft to drive gears on the cutting wheel assemblies. A DC power supply circuit is provided in a support base having a socket for receiving the bottom end of the staff portion for recharging batteries of the shredder. Contacts on the end of the staff portion and in the support base socket connect the shredder battery to the DC power supply.

### BACKGROUND OF THE INVENTION

1. Field of the Invention

The present invention relates to paper shredders. More particularly, the invention relates to a personal hand held paper shredder.

2. Description of the Related Art

Portable hand held paper shredding devices have been the subject of earlier patent documents. For example, in the Japanese patent document JP2001246277 published Sep. 11, 2001 to Takahashi Kunio, a pocket sized manual shredder is taught. A knob partially projecting from the shredder housing is turned to rotate a pair of cutters to shred paper. In U.S. Pat. No. 4,869,435 issued Sep. 26, 1999 to Pistorius et al., a shredder similar in form to that of Kunio is taught, however, the device includes an electric motor with gearing for driving the cutters. The Pistorius et al. shredder has an on/off switch and a reversing switch for actuating the electric motor and a snap on connecting enclosure for storing the shredded paper.

Both the U.S. Pat. No. 5,054,695 issued Oct. 8, 1991 to Koornhof and the “Piranha” Hand Held Paper Shredder commercially available on the Internet show battery-operated portable shredders having bulky box-shaped housings. These bulky housing typically must be held between the thumb and fingers of one hand when using the devices to shred paper. Holding a shredder in this manner is awkward and may cause strain on the hand during prolong use.

None of the above inventions and patents, taken either singly or in combination, is seen to describe the instant invention as claimed. Thus a hand held paper shredder solving the aforementioned problems is desired.

### SUMMARY OF THE INVENTION

The hand held paper shredder of the present invention is provided in the form of a hollow flag-shaped housing having a flag portion and a staff portion. Elongated cutting wheel assemblies of are cooperatively positioned within the flag portion of the housing and at least one rechargeable battery is mounted in the staff portion of the housing. The flag portion of the housing includes a narrow coextensive gap exposing the cutting wheel assemblies. A switch assembly is also provided in the flag portion. The switch assembly has a spring biased actuating arm that is position within the gap for supplying power from the at least one battery to a motor that is also mounted in the shaft portion of the housing. Wiring within the housing operatively connects the electrical components of the shredder. Drive gearing in the shaft portion connects the motor drive shaft gear to the drive gears of the cutting wheel assemblies. A battery-recharging stand is also provided in the form of a support base having a socket for receiving the bottom end of the handle or staff portion of the shredder. A typical power cord for supplying power from a vehicle cigarette lighter socket or vehicle installed electrical outlet to a DC inlet connector on the staff portion of the shredder for charging the shredder in a car, boat or other vehicle having a DC electrical system.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a hand held paper shredder according to the present invention.

FIG. 2 is a side view of the shredder.

FIG. 3 is a bottom view of the upper housing portion according to the present invention taken at line 3-3 of FIG. 2.

FIG. 4 is a top view of the lower housing portion according to the present invention taken at line 4-4 of FIG. 2.

FIG. 5 is a bottom view of the shredder according to the present invention.

FIG. 6 is a perspective view of the accessorized battery charging stand for the shredder according to the present invention.

FIG. 7 is a perspective view of a typical 12 Volt DC power cord that is used for recharging the shredder according to the present invention from a 12 volt source in a vehicle.

Similar reference characters denote corresponding features consistently throughout the attached drawings.

### DETAILED DESCRIPTION OF THE PREFERRED EMBODIMENT

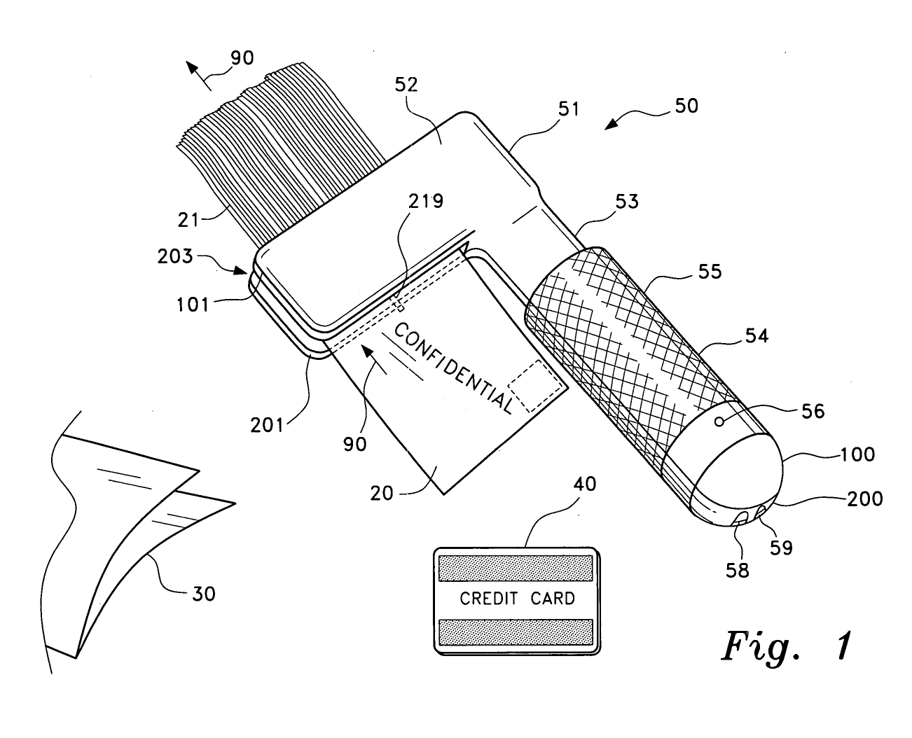

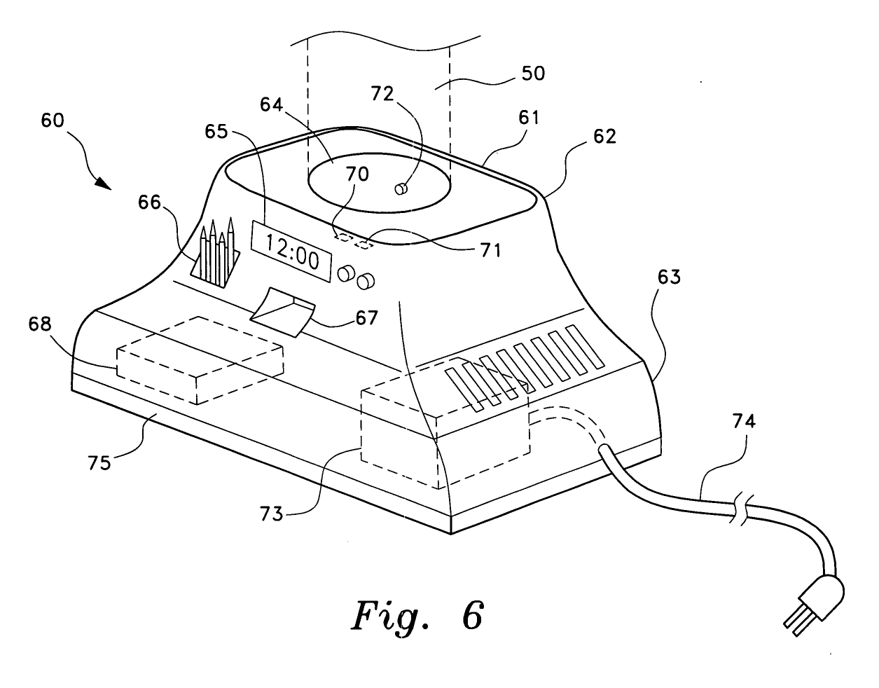

As shown in FIGS. 1 and 6, the present invention is a hand held portable personal paper shredder 50 for destroying confidential and personal information on paper or thin plastic sheets and further includes an accessorized shredder battery-recharging stand 60. The shredder is sized to quickly make shreds 21 out of envelopes, folded sheets of paper 30, credit cards and the like.

The shredder 50 is provided in the form of a hollow flag-shaped housing 51. The shredder cutting wheel assemblies are positioned within the flag portion 52 of housing 51 and means for driving the cutting wheel assemblies is housed in the staff portion 53 of housing 51. A recharging stand 60 is provided in the form of base 61 having a handle-receiving socket 64 for the staff portion 53 of shredder 50.

Preferably housing 51 and base 61 are formed from a suitable plastic or metal material. Staff portion 53 forms a handle 54 sized to fit a human hand that is provided with a grip enhancing surface feature 55 such as knurling, finger grooves, abrasions and the like.

Handle 54 includes a low battery indicator light 57 at one end. Detent elements 56 are formed at a second end of handle 54 for cooperating with corresponding detent elements 72 provided in the handle-receiving socket 64 of base 61. Extending from the bottom of handle 54 are contacts 58 and 59 positioned for electrically conductive engagement with contacts 70 and 71 of charging circuit 73 that are position in the bottom of socket 64.

Base 61 includes an upper base portion 62 and a lower base portion 63. Battery recharging circuitry 73 is preferably housed within lower base portion 63 and connected to contacts 70, 71. Accessories may be added to or formed in base 61, such as a clock 65, a pen and pencil receiving pocket 66, a recessed tray 67 for sticky post-it note pads or a storage compartments 68 can be formed in the upper and lower portions 62, 63 of base 61. An electrical cord 74 is provided to connect the battery recharging circuitry 73 to any household electrical outlet. The bottom of the base 61 is provided with a rubberized gripping or suction cup-like feature so that the base 61 sits securely on a flat surface such as a tabletop. VELCRO™ type fasteners may also be used and the base restructured for wall mounting.

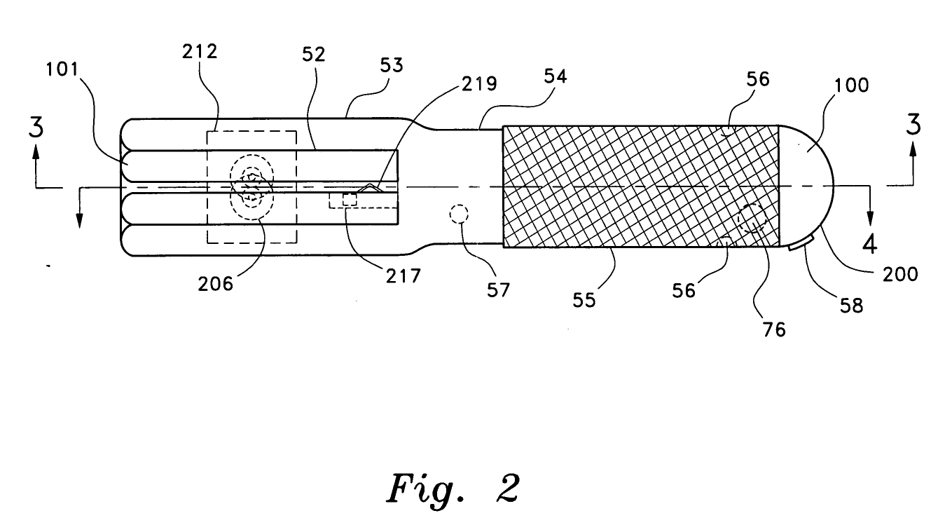

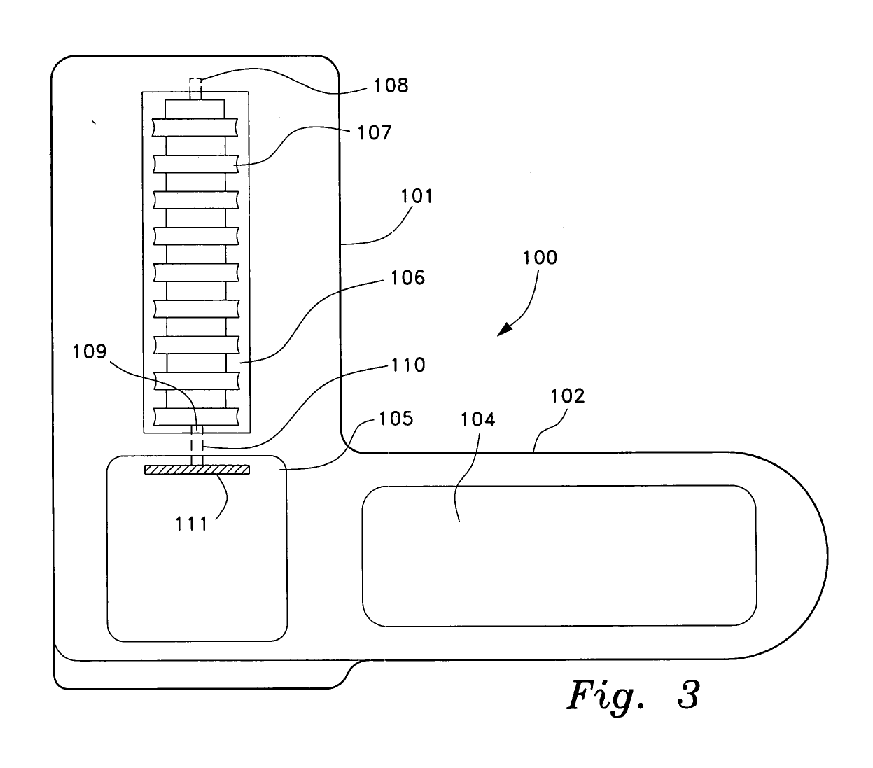

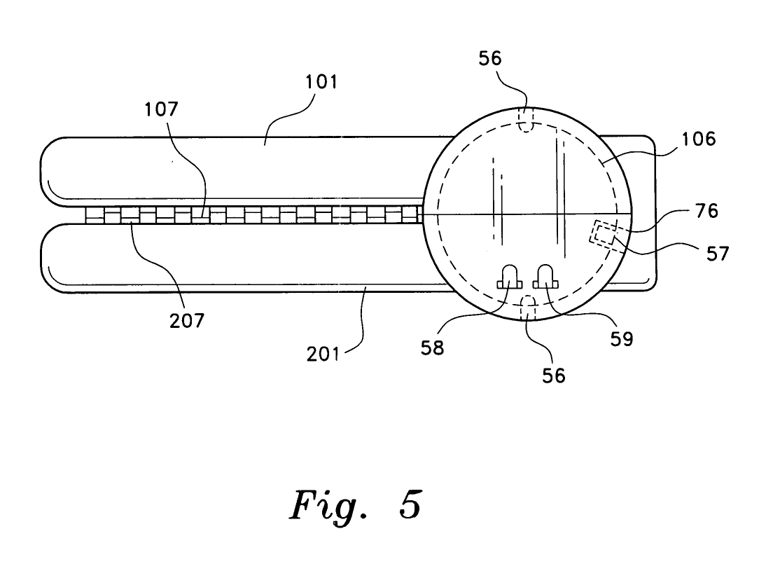

Referring generally to FIGS. 2-5, a hollow housing 51 includes an upper housing portion 100 and a mating lower housing portion 200. FIG. 3 shows that housing portion 100 is formed with an upper flag section 101 and an upper staff section 102. The upper flag section 101 has a recess 106 containing an upper gripping and cutting wheel assembly 107. One end 108 of the drive shaft of cutting wheel assembly 107 is rotatably supported at the distal end of upper flag section 101. A second end 109 of the drive shaft is rotatably supported at the proximal end of upper flag section 101. End 109 passes through an axle passage 110 and extends into a second recess 105 formed in a top portion of upper staff section 102. A wheel turning gear 111 is affixed to the extended portion of end 109 of the drive shaft. A battery receiving recess 104 is provided in a bottom portion of upper staff section 102.

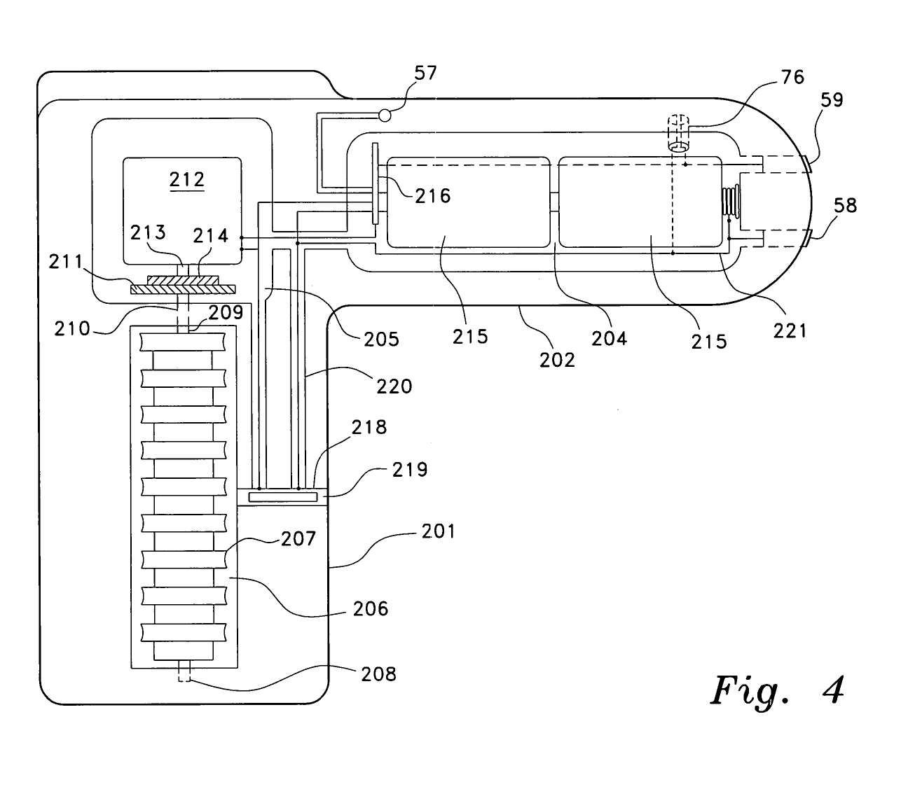

Turning now to FIG. 4, housing portion 200 is formed with a lower flag section 201 and a lower staff section 202. The lower flag section 201 has a recess 204 containing a lower gripping and cutting wheel assembly 207. One end 208 of the drive shaft of lower cutting wheel assembly 207 is rotatably supported at the distal end of lower flag section 201. A second end 209 of the drive shaft is rotatably supported at the proximal end of lower flag section 201. End 209 passes through an axle passage 210 and extends into a second recess 205 formed in a top portion of lower staff section 202. A wheel turning gear 211 is affixed to the extended portion of end 209 of the drive shaft.

Housing portion 200 supports all the electrical components of shredder 50. A small DC motor 212 and a gearing arrangement 214 are mounted in recess 205. The drive shaft 213 of motor 212 is connected by the gearing arrangement 214 positioned in recess 205 so as to drive wheel turning gears 111 and 211 in opposing directions when the upper housing portion 100 and the lower housing portion 200 are secured together. At least one rechargeable battery 215 is housed in a recess 204 in a bottom portion of lower staff section 202. Preferably the batteries are Ni Cad or Nickel metal Hydride batteries. A motor actuating switch assembly 217 is received in a small recess 218 in lower flag section 201.

In addition, recess 204 supports a circuit board 216 having appropriate circuitry designed for performing the following functions:
Continuously monitoring the charge on batteries 215 and energizing the low battery light 57 on the exterior of lower staff section 202 when appropriate;
Delaying deactivation of the motor 212 until the shreds 21 pass through the cutting wheel assemblies 107, 207;
Providing re-charging current via contacts 58 and 59 on a bottom end of lower staff section 202 to batteries 215 from recharging stand 60 when appropriate; and
Providing a re-charging current from a DC inlet connector 76 in a bottom wall portion of lower staff section 202 to batteries 215 when appropriate.

Wiring 221 is provided through interior passageways 220 to operatively interconnect all the electrical components of shredder 50. Switch assembly 217 includes a spring biased actuator arm 219 that extends into the narrow gap 203 between upper flag section 101 and lower flag section 201 as shown in FIG. 2.

When an item to be shredded is inserted into gap 203 in the direction of arrows 90 as shown in FIG. 1, the spring biased actuator arm 219 is moved out of the gap and closes the contacts of switch assembly 217. Once the trailing edge of the item being shredded passes actuator arm 219, arm 219 moves back into the gap, however, the delay circuitry on circuit board 215 allows motor 212 to remain activated until the item has been totally shredded.

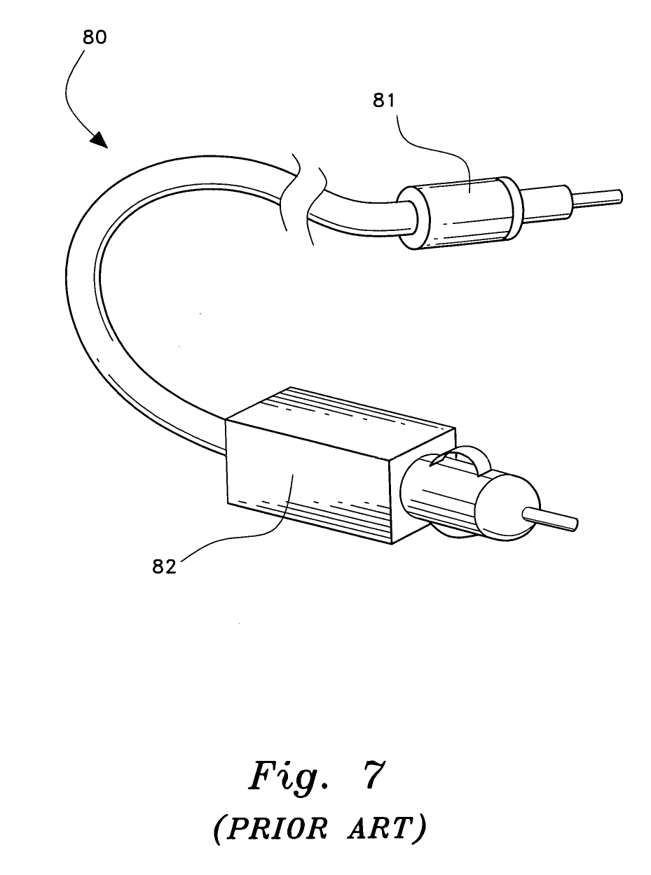

FIG. 7 shows a typical prior art power cord 80 for supplying DC current from the electrical system of a vehicle such as a car, boat, etc., to portable battery-operated electronic devices. A first end of cord 80 contains a male connector 81 that plugs into inlet connector 76 of the shredder 50.

It is to be understood that the present invention is not limited to the embodiment described above, but encompasses any and all embodiments within the scope of the following claims.

1. A personal hand held shredder comprising:
a hollow flag-shaped housing having a flag portion and a staff portion;
said housing includes an upper housing portion and a mating lower housing portion;
said upper housing portion is formed with an upper flag section and an upper staff section;
said lower housing portion is formed with a lower flag section and a lower staff section;
a narrow coextensive gap between said upper flag section and said lower flag section of said flag portion;
a first elongated cutting wheel assembly positioned within said upper flag section of said housing;
a second elongated cutting wheel assembly positioned within said lower flag section of said housing; and
means for driving said cutting wheel assemblies positioned within said housing.

2. The personal hand held shredder according to claim 1, wherein said driving means includes:
a small DC motor having a drive shaft with a drive gear;
a gearing arrangement positioned to engage the drive shaft drive gear and a gear on each said cutting wheel assembly;
at least one rechargeable battery; and
a switch assembly having an actuator arm extending into said gap.

3. The personal hand held shredder according to claim 2, wherein said upper and lower flag sections have an elongated flag recess for rotatably supporting said first and second elongated cutting wheel assemblies.

4. The personal hand held shredder according to claim 3, wherein a second recess is formed in a top portion of each of said upper and lower staff sections for housing said motor and said gearing arrangement.

5. The personal hand held shredder according to claim 4, wherein a third recess is formed in a bottom portion of each of said upper and lower staff sections for housing said at least one rechargeable battery.

6. The personal hand held shredder according to claim 5, wherein said switch assembly is positioned in a switch recess in said lower flag section.

7. The personal hand held shredder according to claim 6, further including:
a low battery light provided in a wall portion of said lower staff section;
a pair of electrical contacts on a bottom end of said lower staff section; and
a circuit board mounted in said third recess of said lower staff section having circuitry for continuously monitoring the charge on said at least one re-chargeable battery and energizing said low battery light when appropriate, delaying deactivation of said motor until the shreds pass through said cutting wheel assemblies, and providing re-charging current via said contacts to said at least one battery from said recharging stand when appropriate.

8. The personal hand held shredder according to claim 7, wherein an outer surface of said staff portion includes a surface gripping feature for secure grasping of a portion of said staff portion which servers as a handle.

9. The personal hand held shredder according to claim 8, further including
a DC inlet connector provided in said wall portion of said lower staff section; and
a recharging stand connectable to an AC outlet;
wherein said circuitry additionally provides a re-charging current from said DC inlet connector to said at least one battery when appropriate.

10. The personal hand held shredder according to claim 9, further including cooperating detent elements on said bottom end of said staff portion and in a socket provided in said recharging stand for securely seating said staff portion in said socket.

11. The personal hand held shredder according to claim 10, wherein said recharging stand includes at least one accessory in the form of a pocket for receiving pencils and pens, a recessed tray for sticky notes, a clock, and a storage compartment.

12. The personal hand held shredder according to claim 9, further including a power cord for providing DC current from a vehicle DC source to said DC inlet connector.
